(19) United States
(12) Patent Application Publication
(10) Pub. No.: US 2022/0369774 A1
(43) Pub. Date: Nov. 24, 2022

(54) Flexible Misting Umbrella Apparatus

(71) Applicant: Andrea Sedzmak, Hanford, CA (US)

(72) Inventor: Andrea Sedzmak, Hanford, CA (US)

(21) Appl. No.: 17/323,262

(22) Filed: May 18, 2021

(51) Int. Cl. A45B 23/00; A45B 9/02; A45B 17/00; A45B 25/02; B05B 9/08

(52) U.S. Cl. CPC A45B 23/00; A45B 9/02; A45B 17/00; A45B 25/02; B05B 9/085; A45B 2025/003

(57) ABSTRACT

A flexible misting umbrella apparatus for keeping a user cool in hot environments includes a handle having a handle sidewall, a handle top side, and a handle bottom side defining a handle cavity. A water reservoir is coupled within the handle cavity. A pump is coupled within the handle. A trigger is coupled to the handle and is in operational communication with the pump. A flexible tubing extends from the handle top side and is in fluid communication with the pump. The flexible tubing is malleable under the force of a user's hand and otherwise maintains its shape. An umbrella frame is coupled to the flexible tubing. A plurality of nozzles is coupled to the umbrella frame and is in fluid communication with the flexible tubing to release mist when the trigger activates the pump. An umbrella canopy is coupled to the umbrella frame.

### CROSS-REFERENCE TO RELATED APPLICATIONS

Not Applicable

### STATEMENT REGARDING FEDERALLY SPONSORED RESEARCH OR DEVELOPMENT

Not Applicable
(d) THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to umbrella devices and more particularly pertains to a new umbrella device for keeping a user cool in hot environments. The present device includes a reservoir integrated into a handle and a flexible shaft. A plurality of nozzles is integrated into each rib of the umbrella.

### (2) Description of Related Art Including Information Disclosed Under 37 CFR 1.97 and 1.98

The prior art relates to umbrella devices. Known devices with integrated climate control often include a reservoir separate from the handle. These known devices have a rigid or telescoping shaft and cannot be bent.

### BRIEF SUMMARY OF THE INVENTION

An embodiment of the disclosure meets the needs presented above by generally comprising a handle having a handle sidewall, a handle top side, and a handle bottom side defining a handle cavity. A water reservoir is coupled within the handle. The water reservoir is coupled within the handle cavity and has a fill port extending through the handle sidewall. A pump is coupled within the handle and is in fluid communication with the water reservoir. A battery compartment is coupled to the handle. The battery compartment has a plurality of batteries in operational communication with the pump. A trigger is coupled to the handle. The trigger is in operational communication with the pump. A flexible tubing is coupled to the handle. The flexible tubing extends from the handle top side and is in fluid communication with the pump. The flexible tubing is malleable under the force of a user's hand and otherwise maintains its shape. An umbrella frame is coupled to the flexible tubing. A plurality of nozzles is coupled to the umbrella frame. Each nozzle is in fluid communication with the flexible tubing to release mist when the trigger activates the pump. An umbrella canopy is coupled to the umbrella frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a flexible misting umbrella apparatus according to an embodiment of the disclosure.

FIG. 2 is a detail view of an embodiment of the disclosure.

FIG. 3 is an in-use side elevation view of an embodiment of the disclosure.

FIG. 4 is a bottom plan view of an embodiment of the disclosure.

FIG. 5 is a front elevation view of an embodiment of the disclosure.

FIG. 6 is a detail view of an embodiment of the disclosure.

### DETAILED DESCRIPTION OF THE INVENTION

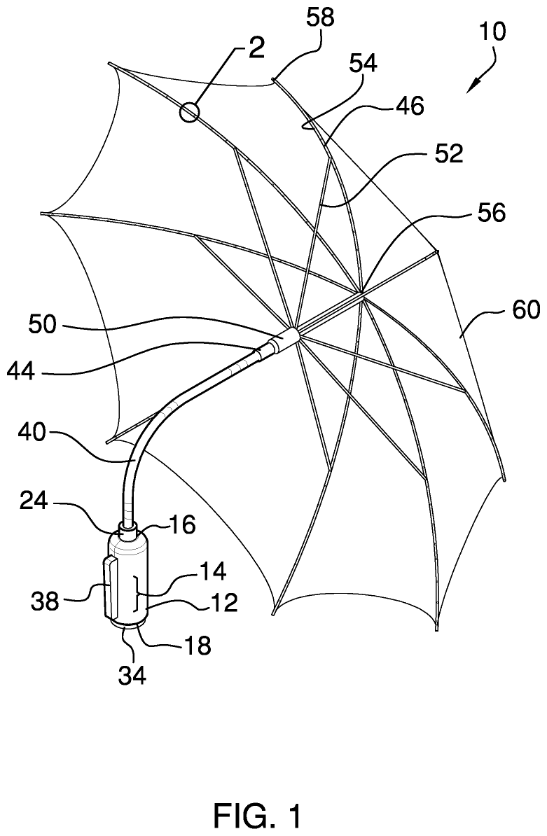

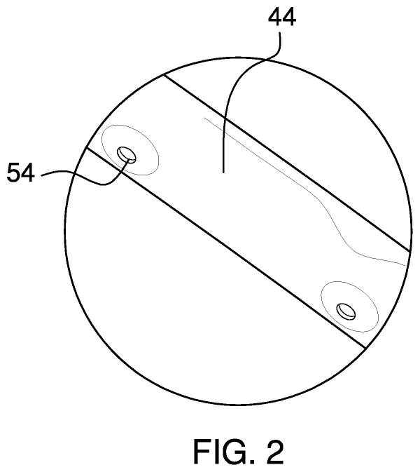

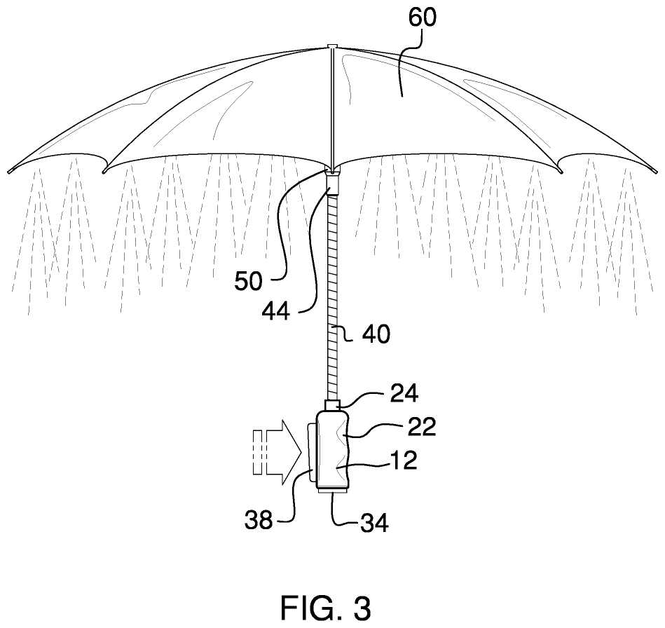

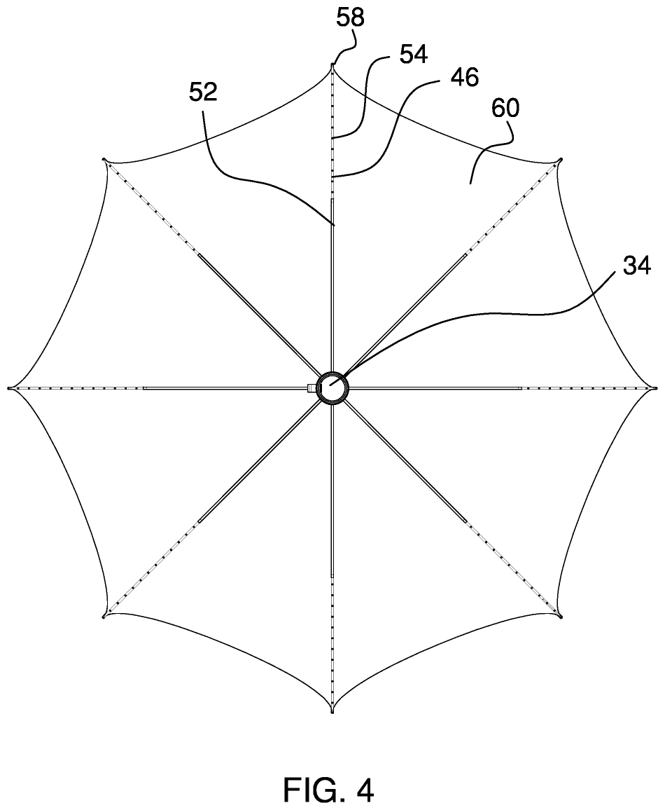

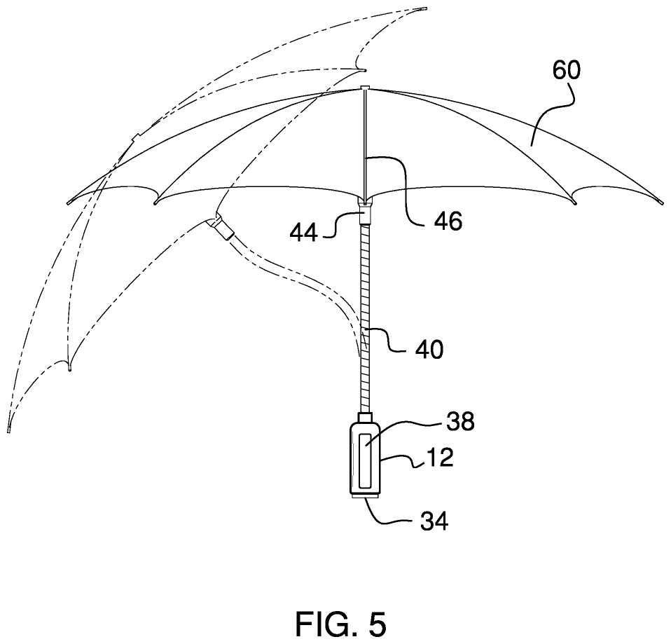

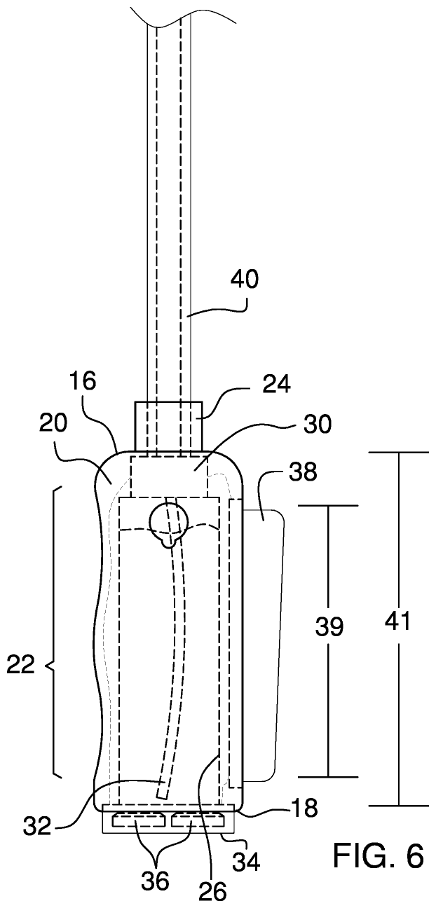

With reference now to the drawings, and in particular to FIGS. 1 through 6 thereof, a new umbrella device embodying the principles and concepts of an embodiment of the disclosure and generally designated by the reference numeral 10 will be described.

As best illustrated in FIGS. 1 through 6, the flexible misting umbrella apparatus 10 generally comprises a handle 12 having a handle sidewall 14, a handle top side 16, and a handle bottom side 18 defining a handle cavity 20. The handle sidewall 14 may have an ergonomic curved portion 22 for user comfort. The handle top side 16 may have a collar portion 24 for structural support.

A water reservoir 26 is coupled within the handle 12. The water reservoir 26 is coupled within the handle cavity 20 and has a fill port 28 extending through the handle sidewall 14. The fill port 28 may be located closer to the handle top side 16 to minimize leakage. A pump 30 is coupled within the handle 12. The pump 30 may be positioned between the water reservoir 26 and the handle top side 16 and is in fluid communication with the water reservoir 26. The pump 30 may have a draw tube 32 extending into the water reservoir 26.

A battery compartment 34 is coupled to the handle 12. The battery compartment 34 may be coupled to the handle bottom side 18 and has a plurality of batteries 36 in operational communication with the pump 30. A trigger 38 is coupled to the handle 12. The trigger 38 may be coupled to the handle sidewall 14 and may have a trigger height 39 equal to 75% or more of a handle height 41 of the handle. The trigger 38 is in operational communication with the pump 30 to activate the pump 30 when squeezed.

A flexible tubing 40 is coupled to the handle 12. The flexible tubing 40 extends through the collar portion 24 and is in fluid communication with the pump 30. The flexible tubing 40 is malleable under the force of a user's hand and otherwise maintains its shape.

An umbrella frame 42 is coupled to the flexible tubing 40. The umbrella frame may include a rigid shaft 44 coupled to the flexible tubing 40 and a plurality of ribs 46 with each rib 46 being hollow and in fluid communication with the flexible tubing 40 through the rigid shaft 44. The plurality of ribs 46 extends from a shaft top end 48 of the rigid shaft. Each rib 46 may be arcuate. A runner 50 may be slidably coupled to the rigid shaft 44 and a plurality of stretcher arms 52 extend from the runner 50 to the plurality of ribs 46. Each stretcher arm 52 is pivotably coupled to the runner 50 and the respective rib 46 to move between a collapsed position and an extended position.

A plurality of nozzles 54 is coupled to the umbrella frame 42. Each nozzle 54 is in fluid communication with the flexible tubing 40 through the umbrella frame 42 to release mist when the trigger 38 activates the pump 30. The plurality of nozzles 54 may be coupled to the plurality of ribs 46 with each rib 46 having the plurality of nozzles 54 evenly spaced between a rib proximal end 56 and a rib distal end 58. An umbrella canopy 60 is coupled to the umbrella frame 42.

In use, the water reservoir 26 is filled through the fill port 28. The flexible tubing 40 is then bent into the desired shape and position. The trigger 38 is then used to activate the pump 30 to release mist through the plurality of nozzles 54 to cool the user.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A flexible misting umbrella apparatus comprising:
a handle having a handle sidewall, a handle top side, and a handle bottom side defining a handle cavity;
a water reservoir coupled within the handle, the water reservoir being coupled within the handle cavity and having a fill port extending through the handle sidewall;
a pump coupled within the handle, the pump being in fluid communication with the water reservoir;
a battery compartment coupled to the handle, the battery compartment having a plurality of batteries in operational communication with the pump;
a trigger coupled to the handle, the trigger being in operational communication with the pump;
a flexible tubing coupled to the handle, the flexible tubing extending from the handle top side and being in fluid communication with the pump, the flexible tubing being malleable under the force of a user's hand and otherwise maintaining its shape;
an umbrella frame coupled to the flexible tubing;
a plurality of nozzles coupled to the umbrella frame, each nozzle being in fluid communication with the flexible tubing to release mist when the trigger activates the pump; and
an umbrella canopy coupled to the umbrella frame.

2. The flexible misting umbrella apparatus of claim 1 further comprising the umbrella frame including a plurality of ribs, each rib being hollow and being in fluid communication with the flexible tubing; the plurality of nozzles being coupled to the plurality of ribs.

3. The flexible misting umbrella apparatus of claim 2 further comprising each rib having the plurality of nozzles evenly spaced between a rib proximal end and a rib distal end.

4. The flexible misting umbrella apparatus of claim 2 further comprising the umbrella frame including a rigid shaft coupled to the flexible tubing, the plurality of ribs extending from a shaft top end of the rigid shaft, a runner slidably coupled to the rigid shaft, and a plurality of stretcher arms extending from the runner to the plurality of ribs, each stretcher arm being pivotably coupled to the runner and the respective rib to move between a collapsed position and an extended position.

5. The flexible misting umbrella apparatus of claim 1 further comprising the battery compartment being coupled to the handle bottom side.

6. The flexible misting umbrella apparatus of claim 1 further comprising the handle sidewall having an ergonomic curved portion.

7. The flexible misting umbrella apparatus of claim 1 further comprising the trigger being coupled to the handle sidewall.

8. The flexible misting umbrella apparatus of claim 7 further comprising the trigger having a trigger height equal to 75% or more of a handle height of the handle.

9. The flexible misting umbrella apparatus of claim 1 further comprising the handle top side having a collar portion; the flexible tubing extending through the collar portion.

10. A flexible misting umbrella apparatus comprising:
a handle having a handle sidewall, a handle top side, and a handle bottom side defining a handle cavity, the handle sidewall having an ergonomic curved portion, the handle top side having a collar portion;
a water reservoir coupled within the handle, the water reservoir being coupled within the handle cavity and having a fill port extending through the handle sidewall;
a pump coupled within the handle, the pump being in fluid communication with the water reservoir;
a battery compartment coupled to the handle, the battery compartment being coupled to the handle bottom side, the battery compartment having a plurality of batteries in operational communication with the pump;
a trigger coupled to the handle, the trigger being coupled to the handle sidewall, the trigger having a trigger height equal to 75% or more of a handle height of the handle, the trigger being in operational communication with the pump;
a flexible tubing coupled to the handle, the flexible tubing extending through the collar portion and being in fluid communication with the pump, the flexible tubing being malleable under the force of a user's hand and otherwise maintaining its shape;
an umbrella frame coupled to the flexible tubing, the umbrella frame including a plurality of ribs, each rib being hollow and being in fluid communication with the flexible tubing, the umbrella frame including a rigid shaft coupled to the flexible tubing, the plurality of ribs extending from a shaft top end of the rigid shaft, a runner slidably coupled to the rigid shaft, and a plurality of stretcher arms extending from the runner to the plurality of ribs, each stretcher arm being pivotably coupled to the runner and the respective rib to move between a collapsed position and an extended position;
a plurality of nozzles coupled to the umbrella frame, each nozzle being in fluid communication with the flexible tubing to release mist when the trigger activates the pump, the plurality of nozzles being coupled to the plurality of ribs, each rib having the plurality of nozzles evenly spaced between a rib proximal end and a rib distal end; and
an umbrella canopy coupled to the umbrella frame.
